(19) United States
(12) Patent Application Publication
(10) Pub. No.: US 2012/0201665 A1
(43) Pub. Date: Aug. 9, 2012

(54) AIR FLOW DEFLECTOR

(75) Inventors: Mehrzad Tabatabaian, Coquitlam (CA); Stuart Goodwin, Seattle, WA (US)

(73) Assignee: British Columbia Institute of Technology, Burnaby (CA)

(21) Appl. No.: 13/198,632

(22) Filed: Aug. 4, 2011

Related U.S. Application Data
(60) Provisional application No. 61/370,753, filed on Aug. 4, 2010.

(51) Int. Cl. F03B 11/02

(52) U.S. Cl. 415/208.1

(57) ABSTRACT

An air flow deflector comprising (a) a deflector body having an outer surface, the deflector body providing an air passage extending through an inlet, a throat and an outlet, the size of the inlet is greater that the size of the throat; (b) a pair of channels provided between the inlet and the outlet and each of the pair of channels having a venturi profile; and (c) an outlet portion of the air flow deflector provided between the throat and the outlet to provide a gradual transition between the throat and the outlet; wherein the air flow deflector increases an air flow velocity of air entering said inlet.

### TECHNICAL FIELD

The present embodiments relate to an air flow deflector for wind power density enhancement.

### BACKGROUND

In recent years, energy supply, security and environmental concerns have encouraged researchers and industries to look more seriously into renewable energy sources. Among these resources, wind power generation systems have become a major part of renewable energy technologies. Wind energy is abundant, clean and free. Various configurations for wind turbine and wind power plant technologies are generally available and the cost of wind-generated electricity is economically viable when compared to existing hydropower or fossil fuel energy sources. However, wind power technology requires more research and development efforts. Small-wind turbines, new materials, turbine reliability, turbine and system efficiency, and computer simulation are examples of areas that require further study.

In the application of wind power technology, generally it is impossible to extract all of the wind power available from an air flow, as defined in Betz' Law. The theoretical maximum efficiency of a wind turbine was derived by pioneer Albert Betz in 1920. Betz' Law, as it is now known, is a relatively simple proof that the maximum efficiency of a wind turbine, cannot exceed 59%.

The efficiency of a wind turbine is measured as the ratio between the energy extracted from the wind to perform useful work (e.g., electricity) and the total kinetic energy of the wind without the presence of a wind turbine. To understand the reasoning behind Betz' Law, consider a 100% efficiency, i.e., extracting all the kinetic energy from the wind and thus bringing the air to a standstill. The paradox of bringing the air to a stop means that there is no way for the air to drive a rotating machine, so no useful work can be extracted. Now consider the other extreme, i.e., the wind turbine does not reduce the wind speed at all. Again conservation of energy dictates that no useful work will be accomplished by the wind turbine. The maximum theoretical efficiency lies somewhere between these two extremes.

In addition, every wind power extraction device has inefficiencies regardless of the design. The calculation of the wind power generated is impacted by a coefficient of performance (CP) that is specific to each wind power extraction device.

In the field of wind power technology, it is the nonlinear proportionality that is related to the relationship between air stream velocity and wind turbine power which has driven researchers to examine ways to enhance wind velocity and, in turn, the power output of a wind turbine. These devices function to enhance wind velocity, and generally a larger wind velocity is created over a smaller turbine diameter (D) in terms of raw power existing in the air flow.

Notwithstanding the theoretical advantage of velocity over swept area, the economics, manufacturing and assembly complexities have prevented large-scale DAWT technology from becoming widely adopted.

### SUMMARY

Exemplary embodiments of the present invention are directed to air flow deflectors for wind power enhancement.

In one embodiment, the air flow deflector comprises: (a) a deflector body having an outer surface, said deflector body providing an air passage extending through an inlet, a throat and an outlet, with the cross sectional area of said inlet than the cross sectional area of said throat; (b) a pair of channels provided between said inlet and said outlet; each of said pair of channels having a venturi profile; and (c) an outlet portion of said flow detector provided between said throat and said outlet to provide a gradual transition between said throat and said outlet; wherein said air flow deflector increases an air flow velocity of air entering said inlet.

According to another embodiment, a power generating turbine is installed within at least one of said channels.

According to another embodiment, the air flow deflector is used for low wind velocity applications.

According to another aspect, the present invention provides a system of generating wind energy comprising:
(a) a deflector body having an outer surface, said deflector body providing an air passage extending through an inlet, a throat and an outlet, the cross sectional area of said inlet being greater than the cross sectional area of said throat;
(b) a pair of channels provided between said inlet and said outlet; each of said pair of channels having a venturi profile;
(c) an outlet portion of said flow detector provided between said throat and said outlet to provide a gradual transition between said throat and said outlet; and
(d) a controllably operable turbine disposed within at least one of said channels;
wherein said air flow deflector increases an air flow velocity of air entering said inlet.

According to another embodiment, the present invention provides methods for controllably generating electrical power by use of the air deflector and system herein.

A method of generating electrical power comprises a) installing the wind energy system as described herein, wherein the turbine is configured to transmit electrical energy therefrom and b) controllably operating the system to produce and emit electrical power therefrom.

These and other objects and advantages of the present invention will become more apparent to those skilled in the art upon reviewing the description of the preferred embodiments of the invention, in conjunction with the figures and examples.

### DRAWINGS

The following figures set forth embodiments of the invention in which like reference numerals denote like parts. Embodiments of the invention are illustrated by way of example and not by way of limitation in the accompanying figures.

FIG. 1 is an isometric view of an air flow detector according to an embodiment;

FIG. 2 is another isometric view of the air flow detector of FIG. 1;

FIG. 3 is yet another isometric view of the air flow detector of FIG. 1;

FIG. 4 is side view of the air flow detector of FIG. 1;

FIG. 5 is a view on B of FIG. 4;

FIG. 6 is a sectional view on A-A of FIG. 4;

FIG. 7 an alternate schematic view of a cross section of an air flow deflector;

FIG. 8 is a perspective view of an air flow detector according to another embodiment;

FIG. 9 is an alternate schematic view of a cross section of an air flow deflector;

FIG. 10 is an another schematic view of a cross section of an air flow deflector; and

FIG. 11 is a graphical illustration of the velocity profile through the air flow deflector of FIG. 1.

### PREFERRED EMBODIMENTS OF THE INVENTION

The following detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

As used herein, the term “Venturi Effect” or Venturi Profile refers to a “jet effect” wherein, within a fixed space such as a funnel, the velocity of the “fluid” (such as air) increases as the cross sectional area decreases, with the static pressure correspondingly decreasing. According to the laws governing fluid dynamics, a fluid's velocity must increase as it passes through a constriction to satisfy the principle of continuity, while its pressure must decrease to satisfy the principle of conservation of mechanical energy. Thus any gain in kinetic energy a fluid may accrue due to its increased velocity through a constriction is negated by a drop in pressure. An equation for the drop in pressure due to the Venturi effect may be derived from a combination of Bernoulli's principle and the continuity equation.

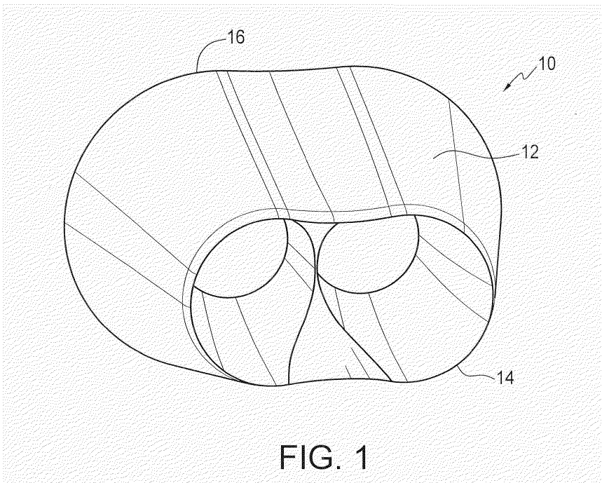

Embodiments of the present invention are shown in FIGS. 1 to 11, wherein like numerals used throughout these

Referring to FIGS. 1, 2 and 3, an air flow deflector 10 is generally shown. The air flow deflector 10 is for increasing the velocity of an air stream prior to the air stream entering a turbine, such as the turbine 21 shown in FIG. 5. Referring also to FIGS. 4 and 5, the air flow deflector 10 includes a deflector body 12 having an inlet 14 and an outlet 16. An air passage 18 extends through the deflector body 12. The shape of the air passage 18 is defined by an inlet channel 20 and a pair of channels 22 and 24, which branch from the inlet channel 20. The channels 22 and 24 are generally identical and the air flow deflector 10 is generally symmetrical about both horizontal and vertical cross-sectional planes. The air flow deflector 10 has a generally central axis 27.

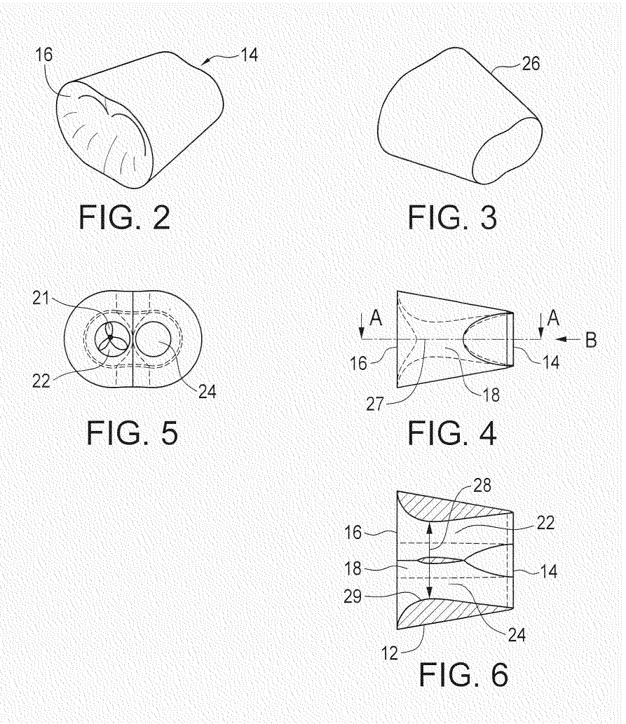

In one embodiment as shown in FIG. 2, a turbine may be placed within one or both of the pair of channels 22 and 24. Alternatively, turbines may also be placed in series installing several turbines in one or both of the pair of channels 22 and 24. The turbines are preferably placed proximate to the outlet 16 of the air flow deflector 10. Placement of a turbine within the channels 22 and 24 of the air flow deflector 10 mitigates turbine noise, NIMBY effect, vibration as well as bird collision with the turbine. The turbine is generally sized for placement within the channels 22 and 24, with the turbine diameter being smaller that the size of the airflow deflector 10.

Turbines are well known in the art and therefore will not be described in detail here.

The channels 22 and 24 located between the inlet 14 and the outlet 16 have an overall venturi shape as shown in FIG. 6, which induces a low pressure zone inside the air flow deflector 10. In an alternative embodiment, the venturi shape extends along the length of the deflector.

The difference between the low pressure zone and the pressure at the inlet 14 causes the velocity of air flowing into the air flow deflector to increase. Further, the gradual transition between a throat 28 and the outlet 16 allows the air flow through the deflector 10 to further develop and increase in velocity.

The ratio between the inlet 14 and the throat 28 of the deflector 10 is between about 1.5:1 to about 3:1. The ratio is generally defined by a comparison of the cross-sectional area of the inlet 14 and the cross-sectional area of the throat 28. In an alternative embodiment, the ratio may be defined by a comparison of the diameter of the inlet 14 and the diameter of the throat 28.

In one embodiment, the deflector body 12 includes a smooth, conical outer shell 26 that is sloped from the inlet 14 toward the outlet 16. The outer shell 26 is generally shaped to provide resistance to the external air flow. This resistance provided by the outer shell 26 is intended to direct flow through the deflector and follow a path of lesser resistance and promote smooth air flow.

The radius of the curvature of the outer shell 26 is between about 1.5 the radius of the inlet 14, about 1.5 the radius of the outlet 16, and infinity. Generally, the profile of the outer shell 26 is smoothly blended to promote laminar air flow. Preferably, the first derivative of the curvature of the outer shell 26 of the deflector body 12 is equal to about zero. The outer shell 26 of the deflector body 12 shown in FIG. 6 has truncated conical profile. It will be appreciated by a person skilled in the art that the outer shell 26 may be any suitable shape and size.

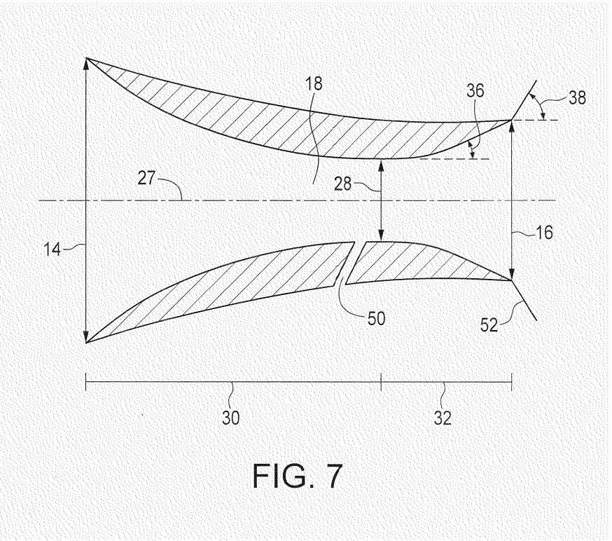

In an alternative embodiment, the outer shell 26 may have a concave profile shown in FIG. 7.

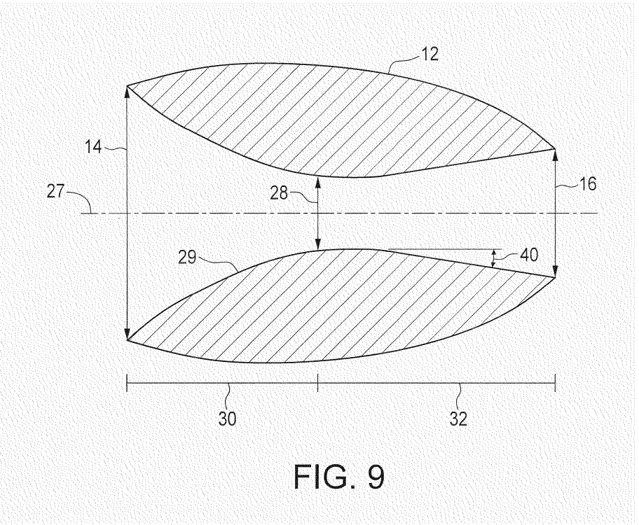

In another alternative embodiment, the outer shell 26 may have a convex profile shown in FIG. 9.

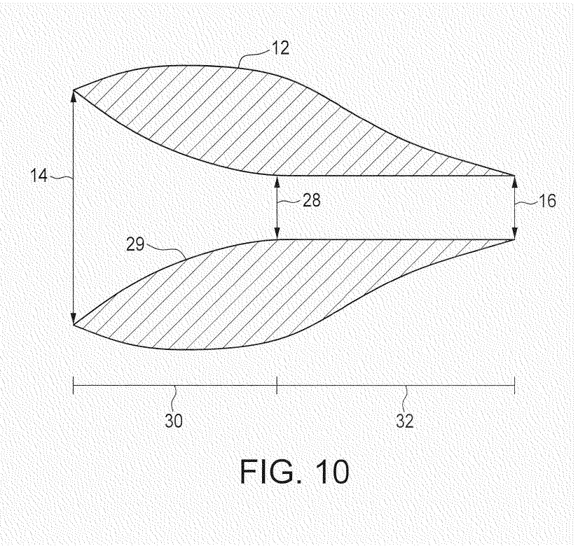

In a further alternative embodiment, the outer shell 26 may have a combination of a convex and a concave profile shown in FIG. 10.

In one embodiment, the outer shell 26 is smooth. Alternatively, the outer shell 26 is textured or has a combination of both smooth and textured surfaces to promote boundary layer control of the air flow.

The air flow deflector 10 is made from a material that is stiff and strong so that there is minimal flexing of the deflector 10 while it is in use. In one embodiment, the air flow deflector 10 is manufactured from Fiberglass reinforced plastic (FRP). FRP has good workability (i.e. is easy to handle and manipulate), stiffness and smoothness. Other materials having similar properties, such as wood, high density plastics, reinforced fabrics or composite materials for example, may alternatively be used.

In operation, the air flow deflector 10 is placed at the inlet of a turbine. The outer shell of the air flow deflector 10 provides resistance to the external air flow while the internal profile allows for air flow through the air passage 18 to be optimized. This results in an increase to the velocity of the air stream entering the turbine.

Referring to FIGS. 6 and 7, the air flow deflector 10 has a generally central axis 27 extending through the air passage 18. An inner surface 29 of an outlet portion of the air flow deflector 10 provided between the throat 28 and the outlet 16 has a generally bell shaped or concave profile extending away from the central axis 27. Angle 36 between a tangential axis that extends along the inner surface 29 of the outlet portion of the air flow deflector 10 and the central axis 27 is between about 12 degrees and about 45 degrees. The exit curve of this outlet portion allows the air flow to follow the curve of the inner surface 29 and enable a generally smooth exit from the air flow deflector 10. Where the flow begins to move away from the inner surface 29 of the curve, an increase in air flow turbulence is evident and the velocity at the outlet 16 shows limited improvement. The length 32 of the deflector body 12 from the throat 28 to the outlet 14 is between 1 times the diameter of the throat 28 and about 3 times the diameter of the throat 28.

Referring to FIG. 7, an air flow deflector 10 according to another embodiment is generally shown. This embodiment includes a flange 52 that is located proximate to the outlet 16 of the air flow deflector 10. The flange 52 generally extends along a perimeter of the outlet 16 and extends outwardly away from the central axis 27. In one embodiment, angle 38 between the flange 52 and the central axis 27 is between about 60 degrees and about 110 degrees. In a preferred embodiment, angle 38 is about 90°. Angle 38 of flange 52 is preferably positioned to enable the airflow through the air flow deflector 10 to be aerodynamically effective.

In another alternative embodiment, the deflector 10 may further include an opening or slot in the deflector body to modify the pressure within channels 22, 24. FIG. 7 illustrates a pressure-modifying slot 50 located proximate to the throat 28.

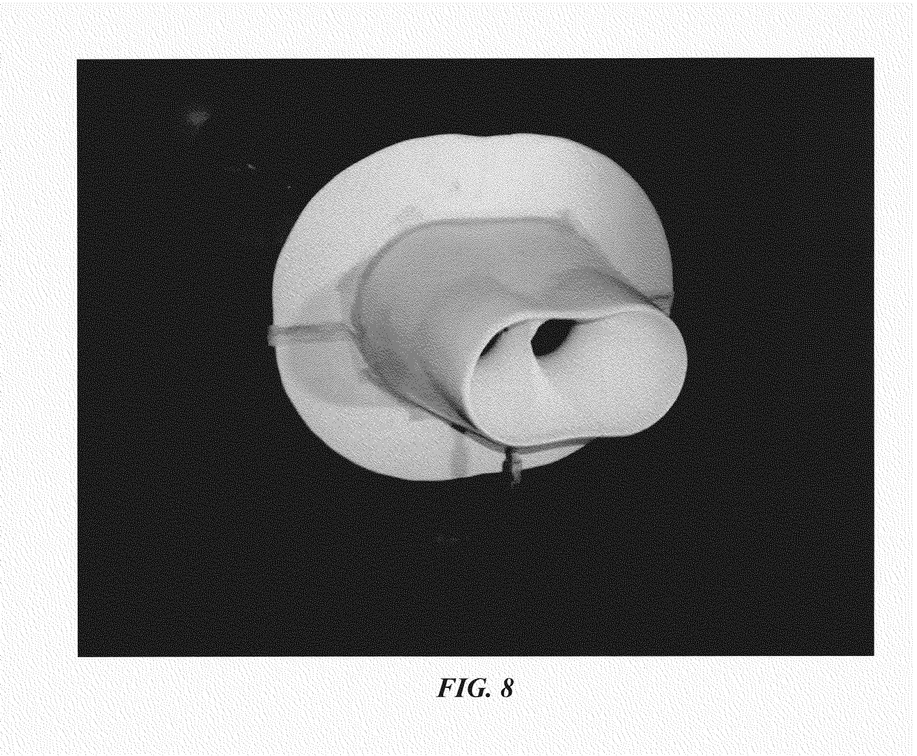

Referring the FIG. 8, flange 52 is shown having a width between about 50 mm and about 150 mm, more preferably 54 mm to 100 mm. In one embodiment, addition of a flange 52 to the air flow deflector 10 resulted in a velocity augmentation ratio of about 1.7.

In yet another embodiment shown in FIGS. 9 and 10, an inner surface 29 of an outlet portion of the air flow deflector 10 provided between the throat 28 and the outlet 16 has a generally conical or frustum shaped profile that gradually extends outwardly toward the outlet 16 and away from the central axis 27. Angle 40 between the axis that extends along the inner surface 29 of the outlet portion of the air flow deflector 10 and the central axis 27 is between about 0 degrees and about 12 degrees.

In one embodiment, shown in FIG. 7, the length 30 of the deflector body 26 from the inlet 14 to the throat 28 is greater than the length 32 of the deflector body 26 from the throat 28 to the 14. In yet another embodiment, shown in FIGS. 9 and 10, the length 30 of the deflector body 26 from the inlet 14 to the throat 28 is less than the length 32 of the deflector body 26 from the throat 28 to the outlet 14. In this embodiment, the center of gravity of the deflector 10 is shifted toward to the outlet 16.

A person skilled in the art would understand that the size and shape of the air flow deflector 10 is intended to encourage the flow of air into the air flow deflector 10 by manipulation of pressure imbalance.

A wind energy system suitable for use in urban environments includes a wind turbine, which converts the kinetic energy in wind into mechanical energy, and a wind catch opening through which wind, or moving air, enters the wind energy system. A turbine (wind turbine) is usually a rotating machine and comprises a plurality of blades oriented such that moving air striking the blades result in blade rotation, which conveys mechanical energy. Wind energy systems also often include generators that convert the mechanical energy generated by wind turbines into electricity.

### EXAMPLES

An air flow deflector as shown in FIG. 1 was tested in a wind tunnel. The deflector was constructed of fiberglass reinforced plastic. The cross-section area of the deflector was approximately 5% of the wind tunnel cross-section. The boundary layer wind tunnel has a cross-sectional dimension of 1016 mm×914 mm which dictated the size of the deflector.

The wind tunnel was set up in a “suck-down” configuration where the air is drawn through the tunnel by a fan. Testing showed that this model of the tunnel had good agreement with the physical reality and demonstrated typical flow characteristics.

The raw tunnel flow profiles were mapped using a TSI VelociCalc™ 9535A hot wire anemometer. A suitable test section and mounting position for the deflector model was identified within the tunnel and the deflector was mounted in the tunnel. The experiment was conducted with a wind tunnel velocity measured at a nominal value of 2.98 m/s.

Experimental velocity measurements were made using the VelociCalc™ 8346 hot wire anemometer. The combination of a telescoping probe on both of the VelociCalc™ anemometers used and small steel stands allowed measurement traverses to be made almost anywhere within the tunnel or within the air flow deflector with minimal disruption to the flow. Owing to the qualitative nature of the testing on air flow deflector, velocity data was reported as collected and temperature and pressure corrections were omitted. Flow visualization in the form of yarn and cloth tufts was also used to qualitatively observe the flow patterns in and around the air flow deflector.

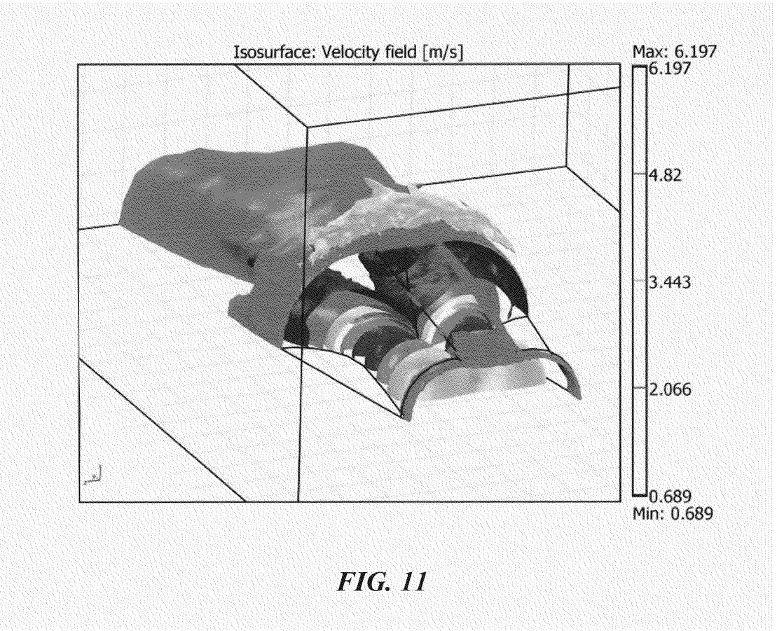

The k-ω turbulence method models the transport of turbulent kinetic energy (k) and the transport of the dissipation per unit turbulent kinetic energy (ω) of the airflow. The large separated-flow wake behind the air flow deflector shown in FIG. 11 demonstrate a wall-free mixing shear flow zone and illustrates that the flow inside air flow deflector from the throat towards the outlet is dominated by adverse pressure gradients.

Flow visualization using the tufts of yarn and fabric ribbons was used to provide a qualitative analysis of the flow regime existing in and around the air flow deflector. Observations made using this flow visualization were used to analyze modifications that were made to the air flow deflector to adjust the less-desirable flow patterns. The flow visualization suggested that air flow may be pushed through the air flow deflector by modifying the body of the air flow deflector, namely the exterior surface.

Various modifications were made to the air flow deflector shown in FIG. 1.

The addition of a 100 mm flange of stiff plastic located at the outlet of the air flow deflector is shown in FIG. 8. Various sizes of flanges were tested. The addition of a flange to the air flow deflector shown in FIG. 1 resulted in a velocity augmentation ratio of 1.7. The wind tunnel to model area ratio was calculated at approximately 27%. Additional rough testing was performed under “open jet” conditions in the wind tunnel. This testing supported the result of a 1.7 times velocity augmentation ratio result. Neglecting other losses, such a ratio would provide a theoretical power improvement of about 5 times over the base air flow velocity.

Additional modifications to the air flow deflector shown in FIG. 1 included an extended throat-to-outlet curve as shown in FIG. 7. This modification demonstrated an improvement in air flow patterns and an increase in air flow velocity which resulted in a velocity augmentation ratio of 1.4.

Further additional testing using flow visualization and CFD modeling also indicated that improvements to extend flow into the region beyond the throat led to improvements in the velocity augmentation ratio.

Modification to the air flow deflector shown in FIG. 1 to include a modified ramp of plastic material placed between the outlet and the flange also yielded air flow improvement.

A person skilled in the art would understand that the above-noted modifications maybe be consider alone or in combination in order to demonstrate qualitative improvement in the air flow patterns and velocity augmentation ratios.

Specific embodiments have been shown and described herein. However, modifications and variations may occur to those skilled in the art. All such modifications and variations are believed to be within the scope and sphere of the present embodiments.

1. An air flow deflector comprising:
(a) a deflector body having an outer surface, said deflector body providing an air passage extending through an inlet, a throat and an outlet, the cross sectional area of said inlet being greater than the cross sectional area of said throat;
(b) a pair of channels provided between said inlet and said outlet; each of said pair of channels having a venturi profile; and
(c) an outlet portion of said flow detector provided between said throat and said outlet to provide a gradual transition between said throat and said outlet;
wherein said air flow deflector increases an air flow velocity of air entering said inlet.

2. The air flow deflector according to claim 1, wherein said airflow may further include a gas flow.

3. The air flow deflector of claim 1 wherein said pair of channels branch from the inlet.

4. The air flow deflector of claim 1 wherein said pair of channels are substantially symetrical.

5. The air flow deflector of claim 1 wherein said venturi profile provides a means to induce a low pressure zone inside said deflector.

6. The air flow deflector of claim 1 additionally comprising a flange proximate to outlet portion.

7. The air flow deflector of claim 1 additionally comprising a flange proximate to outlet portion and wherein flange has a width of from between 50 mm and 150 mm.

8. The air flow deflector of claim 1 additionally comprising an opening in the deflector body which is capable of modifying pressure within the pair of channels.

9. The air flow deflector of claim 1 wherein an inner surface of the outlet portion has a conical shaped profile.

10. The air flow deflector of claim 1 wherein an inner surface of the outlet portion has a frustum shaped profile.

11. The air flow deflector of claim 1 wherein the outlet portion has an inner surface and wherein there is an axis between the inner surface and the outlet portion which is off-set by from about 0 degrees to 12 degrees.

12. The air flow deflector of claim 1 wherein a first length (30) of the deflector body from the inlet to the throat is greater than a second length (32) from deflector body to the outlet.

13. The air flow deflector of claim 1 wherein a first length (30) of the deflector body from the inlet to the throat is less than a second length (32) from deflector body to the outlet.

14. A wind energy system comprising:
(a) a deflector body having an outer surface, said deflector body providing an air passage extending through an inlet, a throat and an outlet, the cross sectional area of said inlet being greater than the cross sectional area of said throat;
(b) a pair of channels provided between said inlet and said outlet; each of said pair of channels having a venturi profile;
(c) an outlet portion of said flow detector provided between said throat and said outlet to provide a gradual transition between said throat and said outlet; and
(d) a controllably operable turbine disposed within at least one of said channels;
wherein said air flow deflector increases an air flow velocity of air entering said inlet.

15. The wind energy system of claim 14 wherein the turbine is proximate to the outlet.

16. The wind energy system of claim 14, wherein said airflow may further include a gas flow.

17. The wind energy system of claim 14 wherein said pair of channels branch from the inlet.

18. The wind energy system of claim 14 wherein said pair of channels are substantially symmetrical.

19. The wind energy system of claim 14 wherein said venturi profile provides a means to induce a low pressure zone inside said deflector.

20. The wind energy system of claim 14 additionally comprising a flange proximate to outlet portion.

21. The wind energy system of claim 14 additionally comprising a flange proximate to outlet portion and wherein flange has a width of from between 50 mm and 150 mm.

22. The wind energy system of claim 14 additionally comprising an opening in the deflector body which is capable of modifying pressure within the pair of channels.

23. The wind energy system of claim 14 wherein an inner surface of the outlet portion has a conical shaped profile.

24. The wind energy system of claim 14 wherein an inner surface of the outlet portion has a frustrum shaped profile.

25. The wind energy system of claim 14 wherein the outlet portion has an inner surface and wherein there is an axis between the inner surface and the outlet portion which is off-set by from about 0 degrees to 12 degrees.

26. The wind energy system of claim 14 wherein a first length (30) of the deflector body from the inlet to the throat is greater than a second length (32) from deflector body to the outlet.

27. The wind energy system of claim 14 wherein a first length (30) of the deflector body from the inlet to the throat is less than a second length (32) from deflector body to the outlet.

28. A method of generating electrical power which comprises
(a) installing the wind energy system of claim 14 wherein turbine configured to transmit electrical energy therefrom; and
(b) controllably operating the system to produce and emit electrical power therefrom.
